(19) United States
(12) Patent Application Publication
(10) Pub. No.: US 2009/0209263 A1
(43) Pub. Date: Aug. 20, 2009

(54) Method for controlling radio cell monitoring system

(76) Inventors: Volkerö Breuer, Bötzow (DE); Michael Färber, Wolfratshausen (DE); Frank Lamprecht, Berlin (DE)

Correspondence Address: STAAS & HALSEY LLP, SUITE 700, 1201 NEW YORK AVENUE, N.W., WASHINGTON, DC, 20005, US

(21) Appl. No.: 12/227,781

(22) PCT Filed: Apr. 27, 2007
(86) PCT No.: PCT/EP2007/054141

§ 371 Date: Apr. 14, 2009

(30) Foreign Application Priority Data
May 26, 2006 (EP) 06010859.4

(51) Int. Cl. H04W 72/00; H04B 17/00

(52) U.S. Cl. 455/450; 455/67.11

(57) ABSTRACT

A method controls a radio cell monitoring system. A standardized radio cell list is transmitted by a device on the network side, the device being allocated to a radio cell of interest. The radio cell list lists radio cells that are adjacent to the radio cell of interest, receiving radio communication terminals monitoring, using the radio cellist, the signals of the adjacent radio cells for a handover or a cell reselection by way of measurement. The respective measurements of the radio communication terminals are transmitted to the device on the network end. At least one priority on the network side is allocated to each radio cell of the radio cell list. Additionally, at least one indication on the network side, indicating which services are offered within the respective radio cell for execution, is allocated to every radio cell of the radio cell list. A receiving radio communication terminal monitors, depending on the signaled priority and depending on the signaled service indication, only a limited number of the radio cells listed in the radio cell list by measurement in order to carry out a service.

### CROSS REFERENCE TO RELATED APPLICATIONS

This application is based on and hereby claims priority to European Application No. EP06010859 filed on May 26, 2006 and International PCT Application No. PCT/EP2007/054141 filed on Apr. 27, 2007, the contents of which are hereby incorporated by reference.

### BACKGROUND OF THE INVENTION

In a radio communication system, a base station sends a radio cell list for causing a receiving radio communication terminal to perform measurements of signals of adjacent radio cells.

On the basis of these measurements—which are generally signaled back to a network side—a handover between radio cells or a reorganization of radio transmission resources between radio cells, called “cell reselection”, can be initiated.

In a GSM radio communication system, for example, a radio cell list is broadcast by a base station of a radio cell considered (BCCH; System Information 2) and can be received by the radio communication terminals allocated to the radio cell. The radio cell list is arranged in a uniform format for the radio communication terminals and is dependent on the status of the radio communication terminals addressed. Status is in this case the state of readiness of the radio communication terminal called “idle mode” or the call state of the radio communication terminal called “connected mode”. In connected mode, associated data channel (SACCH; System Information 5) is used for transmitting the radio cell list.

A GSM radio cell list typically contains up to 32 adjacent radio cells which must be monitored for a handover or for a cell reselection, respectively, by a radio communication terminal considered. The lists used in the “idle” or “connected” mode have the same format but can have identical or different content.

In a WDCMA radio transmission method, radio cell lists are used which are dependent on the status of the radio communication terminals addressed. A first radio cell list is broadcast for radio communication terminals which are in idle mode.

In contrast, a separate, second radio cell list is transmitted via an assigned data channel to each individual radio communication terminal in connected mode.

Even here, several radio communication systems are operated next to one another, wherein a base station or a NodeB or a network access point, respectively, is advantageously used which can handle the respective radio transmission methods of the different radio communication systems.

If, for example, a GSM radio communication system is used or provided in parallel with a WCDMA radio communication system in a spatial area, the base station or NodeB must provide a correspondingly extensive radio cell list for dual-mode radio communication devices which are constructed for handling radio transmissions of several radio transmission standards.

Such a GSM/WCDMA radio cell list can have typically 32 WCDMA intrafrequency neighboring cells, 32 WCDMA interfrequency neighboring cells, 32 GSM neighboring cells and 32 TDD neighboring cells.

On the basis of this extensive radio cell list, a receiving radio communication terminal must then carry out respective measurements of signals of adjacent radio cells with a great expenditure of time and signaling operations in order to be able to perform, if necessary, a handover controlled by the network.

### SUMMARY

It is one possible object, therefore, to specify a method for controlling a radio cell monitoring system which can be carried out with little expenditure particularly in the case of radio communication systems operated in parallel.

The inventors propose a method for controlling a radio cell monitoring system, a uniform radio cell list is transmitted or broadcast by a device at the network end, which is allocated to a radio cell considered. In the radio cell list, radio cells which are adjacent to the radio cell considered are listed, wherein receiving radio communication terminals monitor signals of the adjacent radio cells by measurement for a handover or a cell reselection by the radio cell list. The respective measurements of the radio communication terminals are conveyed to the device at the network end.

According to the proposed method, a priority is allocated to each radio cell of the radio cell list at the network end. In addition, at least one indicator, which specifies what service is offered for handling within the respective radio cell, is allocated to each radio cell of the radio cell list at the network end. For carrying out a service, a receiving radio communication terminal only monitors a limited number of the radio cells specified in the radio cell list by measurement in dependence on the signaled priority and in dependence on the signaled service indicator.

In the method, a selection of radio cells to be monitored with priority and thus a rapid performance of the respective monitoring measurements, by the radio communication terminal is made possible due to the associated priority and service indicator within the radio cell list.

Relevant measurement values of selected radio cells can thus be rapidly acquired and signaled to the network side in order to initiate there, if necessary, a handover or a cell reselection, respectively, after completed evaluation.

As an alternative, the radio communication terminal can initiate a handover or a cell reselection autonomously on the basis of these measurement values.

In the method, a uniform and extensive radio cell list is transmitted to all receiving radio communication terminals independently of the status of the radio communication terminal. The analysis of the radio cell list with respect to the measurements to be performed with priority and the signaling back of the measurement values can be accelerated by the advantageous structure of the radio cell list.

The base station or NodeB transmitting at the network end establishes the content of the radio cell list and prioritizes the adjacent radio cells within the radio cell list.

A receiving radio communication terminal then carries out a limited number of measurements for radio cell monitoring in an intelligent manner in dependence on its own status and on the service to be handled, respectively.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

FIG. 1 shows a radio cell list FZL which is used for radio cell monitoring in the proposed method.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The radio cell list FZL here comprises a total of y cells or radio cell entries, respectively. Each cell thus contains information on a radio cell unambiguously allocated to the numeric field NF, the radio cell can thus be addressed unambiguously via the numeric field.

The numeric field NF forms a first column within the radio cell list FZL.

A second column of the radio cell list FZL contains a priority class PK so that a priority can be allocated to each radio cell.

In the case where several radio cells in the respective allocated priority class PK are equal in value, a measuring sequence for radio cell monitoring can be controlled further via the numeric field. For example, measurements are performed in ascending order of the numeric field NF, the value of the priority class PK remaining the same.

A radio communication terminal which has made a selection by the priority class PK thus begins with the radio cell monitoring of the radio cells allocated to the numeric sequence NF by the ascending numeric sequence.

A third column of the radio cell list FZL contains an idle indicator IA. This can be used for marking
whether the radio cell defined via the numeric sequence NF is only to be monitored by a radio communication terminal which is in idle mode, or
whether the radio cell defined via the numeric sequence NF is only to be monitored by a radio communication terminal which is in connected mode, or whether the radio cell defined via the numeric sequence NF is to be monitored by a radio communication terminal independently of whether it is in connected mode or in idle mode.

This idle indicator IA is of significance, in particular, for a cell reselection to be performed.

A radio communication terminal can also observe the cells or radio cells defined for connected mode preferably temporarily in idle mode. Data services which are handled in the background and which transmit high volumes of data frequently dissolve the physical connection so that the radio communication terminal is in idle mode. However, there is still a logical connection for the service to be handled, there is still a so-called “PDP context”.

If a high volume of data is to be transmitted and no other service is current or is present, the physical connection is re-established. In the case of a still existing “living” context and a cell selection which is based on measurements of the “connected mode” radio cell list, it can be assumed that with a re-establishment of the physical connection, the radio communication terminal has selected a radio cell which can provide an adequate radio carrier.

Providing the idle indicator IA thus leaves open optional possibilities as regards in what form measurements are to be carried out or can be carried out, in idle mode.

A fourth column of the radio cell list FZL contains a radio cell indicator FZA. This can be used for marking whether this is a dependent radio cell or an independent radio cell called “not dependent”.

In this context, the term “dependent radio cell” is understood to be a pico radio cell or a micro radio cell which are virtually “under” a radio cell designated as “umbrella” in space and which, due to this fact, only have to be monitored if the “umbrella” radio cell could be measured, for example, with a certain field strength.

This radio cell indicator FZA is important so that the receiving radio communication terminal can carry out corresponding micro radio cell measurements or pico radio cell measurements. The radio cell designated as “umbrella” is here used as an indicator that “dependent” radio cells can be considered as candidates for a handover and/or for a cell reselection.

By way of example, the radio communication terminal can include or exclude dependent cells in the radio cell monitoring under certain conditions additionally signaled by the network.

A fifth column of the radio cell list FZL contains a radio cell description FZB which specifies the radio transmission standard which is used in the radio cell defined by the numeric field NF.

For example, this signals whether the radio cell to be monitored uses a GSM, a WCDMA or a long-term evolution, LTE, radio transmission of the 3GPP standard.

Three further columns contain information DKA on services or service classes which can be offered by the radio cell or which can be transmitted there. This information is designated as service class indicators DKA1 to DKA3 within the radio cell list.

The service class indicators DKA1 to DKA3 form an important element of the proposalsince they can be used for providing a fast selection of required measurements by mean of the radio communication terminal.

Thus, a radio communication terminal in connected mode only needs to monitor those adjacent radio cells which can offer or handle a service transmitted or requested by the radio communication terminal at all.

In other words, use of the three service class indicators DKA1 to DKA3 makes it possible for the radio communication terminal to restrict the radio cells to be monitored. In an advantageous development, the radio cell list for all radio communication terminals affected is transmitted or broadcast, respectively, by a considered base station, for example via a BCH radio transmission channel.

The possibility of transmitting a further list in the same form but with different content in connected mode in addition to the transmitted or broadcast radio cell list as part of an ongoing optimization is not excluded. This can be done, for example, via an associated data channel to the radio communication terminal.

This would then replace the radio cell list broadcast and allow the possibility of an even more specific priority structuring. This option can lead to optimized operation with certain combinations of characteristics of the radio communication terminal and service class requirements. For example, adjacent-cell observation requests can be distinctly restricted in order to be able to transmit more payload data.

In the case of different system structures, for example temporal frame structures of the different systems or by limitations of the processors and software sequences implemented in the radio communication terminal, situations could arise in which the radio communication terminal cannot monitor all required adjacent radio cells within a required period of time. In this case, radio cells not measured are provided with an “invalid” marking in the measurement report signaled back.

If the radio network then finds within an implemented resource management function that measurements of these radio cells are needed, a corresponding displacement of the allocated priorities can take place by a special radio cell list transmitted via the associated data channel, so that the measurements can be performed and signaled back—in order ultimately to meet the requirements of the resource management function.

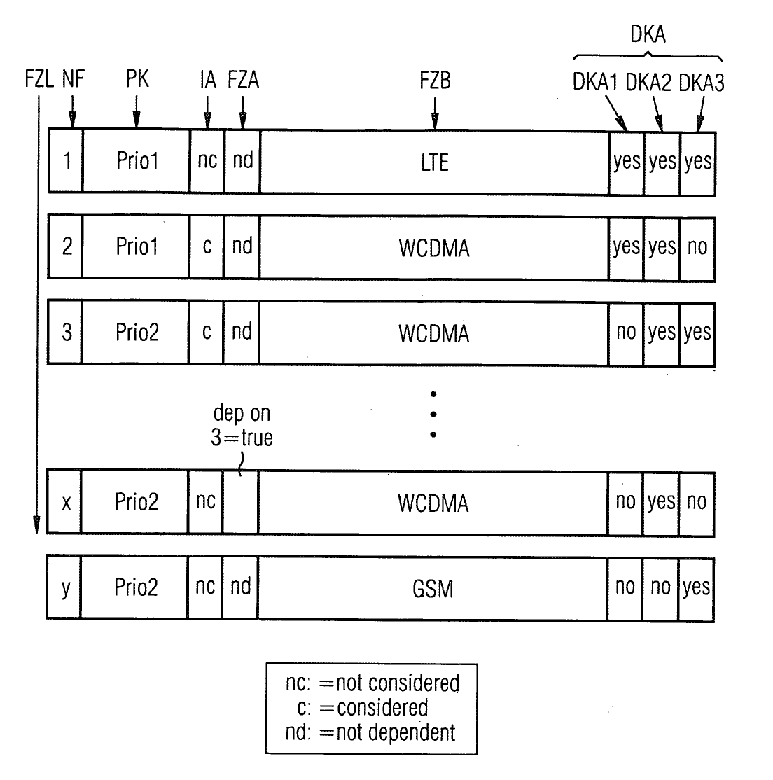

In the text which follows, the entries of the radio cell list FZL shown in FIG. 1 are explained by way of example.

The following applies for the numeric field NF=1:

A first radio cell is defined by the numeric field NF=1. The first radio cell is allocated to a first priority class PK=Prio1.

The idle indicator IA=nc (“not considered”) signals that the first radio cell should not be monitored or should not be used by radio communication terminals in idle mode.

The radio cell indicator FZA is occupied here by FZA=nd (“not dependent”) and signals that the second radio cell is neither a micro radio cell nor a pico radio cell.

The radio cell description FZB=LTE signals that the first radio cell is allocated to an LTE radio communication system.

The service class indicators DKA1=yes, DKA2=yes and DKA3=yes signal that within the first radio cell three services are available or can be handled—for example an EDCH data transmission as first service, an HSDPA data transmission as second service and a voice data transmission as third service.

The following applies to the numeric field NF=2:

A second radio cell is defined by the numeric field NF=2. The second radio cell is allocated to the first priority class PK=Prio1. The idle indicator IA=c (“considered”) signals that the second radio cell is to be monitored or can be used by radio communication terminals in idle mode.

The radio cell indicator FZA=nd (“not dependent”) signals that the second radio cell is neither a micro radio cell nor a pico radio cell.

The radio cell description FZB=WCDMA signals that the radio cell is allocated to a WCDMA radio communication system.

The service class indicators DKA1=yes, DKA2=yes and DKA3=no signal that an EDCH data transmission and an HSDPA data transmission, but voice data transmission can be handled within the radio cell.

The following applies to the numeric field NF=3:

A third radio cell is defined by the numeric field NF=3. The third radio cell is allocated to a second priority class PK=Prio2.

The idle indicator IA=c (“considered”) signals that the third radio cell is to be monitored or can be used in the case of a handover by radio communication terminals in idle mode.

The radio cell indicator FZA=nd (“not dependent”) signals that the third radio cell is neither a micro radio cell nor a pico radio cell.

The radio cell description FZB=WCDMA signals that the radio cell is allocated to a WCDMA radio communication system.

The service class indicators DKA1=no, DKA2=yes and DKA3=yes signal that no EDCH data transmission but an HSDPA data transmission and a voice data transmission can be handled within the radio cell.

The following applies to the numeric field NF=x:

The numeric field NF=x defines a penultimate radio cell. The penultimate radio cell is allocated to the second priority class PK=Prio2.

The idle indicator IA=nc (“not considered”) signals that the penultimate radio cell does not need to be monitored or cannot be used by radio communication terminals in idle mode.

The radio cell indicator FZA=“dep on 3=true” (“dependent on radio cell No. 3=true”) signals that the penultimate radio cell is, for example, a micro radio cell or a pico radio cell within a coverage area of the third radio cell.

The radio cell description FZB=WCDMA signals that the penultimate radio cell is allocated to a WCDMA radio communication system.

The service class indicators DKA1=no, DKA2=yes and DKA3=no signal that no EDCH data transmission and no voice data transmission but an HSDPA data transmission can be handled within the radio cell.

The following applies to the numeric field NF=y:

A last radio cell is defined by the numeric field NF=y. The last radio cell is allocated to the second priority class PK=Prio2.

The idle indicator IA=nc (“not considered”) signals that the last radio cell does not need to be monitored or cannot be used for a handover by radio communication terminals in idle mode.

The radio cell indicator FZA=nd (“not dependent”) signals that the last radio cell is neither a micro radio cell nor a pico radio cell of another radio cell.

The radio cell description FZB=GSM signals that the last radio cell is allocated to a GSM radio communication system.

The service class indicators DKA1=no, DKA2=no and DKA3=yes signal that no EDCH data transmission and no HSDPA data transmission but a voice data transmission can be handled within the radio cell.

In the case of the matching priority class PK=Prio1 of the first and the second radio cells, a receiving radio communication terminal first begins—due to the ascending numeric sequence NF—with measurements of the first and then the second radio cell, assuming that the radio communication terminal performs or requires an EDCH data transmission or an HSDPA data transmission.

Correspondingly, a radio communication terminal in idle mode which is allocated to the first LTE radio cell with the numeric sequence NF=1, would only monitor the second (NF=2) and the third (NF=3) radio cell as suitable candidates for a possible handover or for a possible cell reselection by measurement.

A radio communication terminal which receives a data transmission would first monitor the first radio cell (NF=1) by measurement for carrying out a voice data transmission on the basis of the highest priority class PK.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method of controlling a radio cell monitoring system, the method comprising:
transmitting a uniform radio cell list, which is independent of a status of receiving radio communication terminals, from a device at a network end which is allocated to a considered radio cell, radio cells adjacent to the considered radio cell being listed in the radio cell list, a priority, at least one first indicator specifying what service is offered for handling within a respective radio cell, and at least one second indicator specifying whether the radio cell is only to be monitored by a radio communication terminal in an idle mode, whether the radio cell is only to be monitored by a radio communication terminal in a connected mode or whether the radio cell is to be monitored continuously, independently of the connected mode or the idle mode status, being allocated to each radio cell of the radio cell list and being listed in the radio cell list at the network end;
monitoring signals of the adjacent radio cells by measurement for a handover or a cell reselection at the receiving radio communication terminals using the radio cell list; and
conveying respective measurements of the radio communication terminals to the device at the network end,
wherein one of the receiving radio communication terminals only monitors by measurement a limited number of the radio cells specified in the radio cell list to carry out a service dependent on the signalled priority and the signalled service indicator.

12. The method as claimed in claim 11, wherein a consecutive number is allocated to each radio cell of the radio cell list and is listed in the radio cell list at the network end in order to perform a further subdivision between radio cells of equal priority class.

13. The method as claimed in claim 11, wherein a radio communication terminal in the idle mode uses the at least one second indicator to monitor only those radio cells which are qualified for the connected mode by the at least one second indicator in the case of a still existing logical context of a data link, a physical connection of which is dissolved and which is to be used to transmit a high volume of data, the monitoring being carried out until an associated life of the logical context is extinguished.

14. The method as claimed in claim 11, wherein a radio cell indicator is allocated to each radio cell of the radio cell list and is listed in the radio cell list at the network end, the radio cell indicator signalling whether the radio cell is a micro radio cell or a pico radio cell within another radio cell of the radio cell list.

15. The method as claimed in claim 11, wherein a radio cell description is allocated to each radio cell of the radio cell list and is listed in the radio cell list at the network end, the radio cell description signalling which one of radio transmission methods can be used within the radio cell.

16. The method as claimed in claim 11, wherein information as to all available adjacent radio cells with respective allocated radio transmission methods are transmitted by the radio cell list.

17. The method as claimed in claim 11, wherein the transmitted radio cell list is a first radio cell list, and an additional radio cell list identical to the transmitted first radio cell list is transmitted via an associated data channel to the radio communication terminal, the additional radio cell list transmitted via the associated data channel replacing the first transmitted radio cell list when the first transmitted radio cell list and the additional radio cell list have different contents.

18. The method as claimed in claim 11, wherein the receiving radio communication terminal monitors by measurement the limited number of the radio cells specified in the radio cell list based on information of each radio cell.

19. A radio cell monitoring system, comprising:
a radio communication terminal transmitting a uniform radio cell list, which is independent of a status of receiving radio communication terminals, at a network end which is allocated to a considered radio cell, radio cells adjacent to the considered radio cell being listed in the radio cell list, a priority, at least one first indicator specifying what service is offered for handling within a respective radio cell and at least one second indicator specifying whether the radio cell is only to be monitored by a radio communication terminal in an idle mode, whether the radio cell is only to be monitored by a radio communication terminal in a connected mode or whether the radio cell is to be monitored continuously, independently of the connected mode or the idle mode status, being allocated to each radio cell of the radio cell list and being listed in the radio cell list at the network end, monitoring signals of the adjacent radio cells by measurement for a handover or a cell reselection at the receiving radio communication terminals using the radio cell list, and receiving respective measurements of the receiving radio communication terminals;
wherein one of the receiving radio communication terminals only monitors by measurement a limited number of the radio cells specified in the radio cell list to carry out a service dependent on the signalled priority and the signalled service indicator.

20. A network device generating and transmitting a radio cell list, wherein the radio cell list is arranged to control a radio cell monitoring system as claimed in claim 11.
